(19) United States
(12) Patent Application Publication
(10) Pub. No.: US 2026/0280287 A1
(43) Pub. Date: Sep. 17, 2026

(54) METHOD FOR MACHINE LEARNING-BASED PROBABILISTIC FORECASTING OF ANCILLARY SERVICES UTILIZATION

(71) Applicant: HANWHA SOLUTIONS CORPORATION, Seoul (KR)

(72) Inventor: Amir HOSSINI, Santa Clara, CA (US)

(73) Assignee: HANWHA SOLUTIONS CORPORATION, Seoul (KR)

(21) Appl. No.: 19/079,039

(22) Filed: Mar. 13, 2025

(51) Int. Cl. H02J 3/00

(52) U.S. Cl. CPC H02J 3/004; H02J 2103/30

(57) ABSTRACT

A system for managing an ancillary service (AS) storage, the system including the AS storage; processing circuitry configured to control a utilization of the AS storage; and memory including computer executable instructions configured to cause the system to obtain system projection data, input data into a machine learning (ML) model configured to generate an output based on the system projection data, a capacity of the AS storage, and a generation state of one or more energy generators, the input data including the system projection data, and the output corresponding to a predicted AS utilization, and adjust a utilization threshold of the AS storage based on the predicted AS utilization such that a portion of the capacity of the AS storage is reserved as AS energy, and at least a portion of the capacity of the AS storage is available for a real-time energy service.

### FIELD

The present invention relates to an ancillary service (AS) energy storage system control method and system; and more specifically, to a method and system for controlling the AS energy storage system based on an analysis of predictive factors for forecasting a utilization of energy stored in the AS energy storage system.

### BACKGROUND

Energy generators, especially renewable energy generators, inherently experience fluctuations in electrical generation due to, changes in weather, changes in demand, changes in the condition of the infrastructure, etc. Due to these fluctuations, electrical systems using renewable energy generators commonly use energy storage systems (ESS) to ensure the stability and reliability of the electrical grid. Such ESS commonly include ancillary service systems configured to assist the electrical grid by storing energy in order to compensate for real-time changes in the supply and demand of energy, provide back-up power in case of unexpected demand shifts, stabilize the voltage level in the electrical system by acting as a voltage source when the voltage of the electrical grid is too low or as a voltage sink when the voltage of the electrical grid is too high, provide a black start energy source, etc.

Simultaneous participation of an ESS asset in real-time markets, day-ahead energy markets, and ancillary services (AS) markets rely on forecasts of real-time and day-ahead locational marginal prices (LMPs) as well as forecasts for ancillary services prices for capacity (e.g., regulation up, regulation down and responsive reserves capacity prices). The level of participation in each of the markets is generally determined based on the relative magnitude of the forecasted prices, as the forecasted prices are generally understood as reflecting the demand for energy.

Additionally, incentives are commonly granted for participation in the AS markets, by independent system operators (ISOs), such as the Electric Reliability Council of Texas (ERCOT) and the California Independent System Operator (CAISO), in the day prior to the operating day; however, due to the dynamic and volatile nature of real-time energy market operations, it is rare that all the AS capacity that was procured in the prior day are called up on during the operating day. Thereby, an unutilized capacity remains even during a peak in utilization.

Additionally, as shown in FIG. 1, in the case wherein the day-ahead energy predictions do not match the actual energy demands of the operating day, an increase in the real-time energy prices may occur.

Thereby, as shown in FIGS. 1 and 2, AS systems, which rely on a set value for the utilization of the AS storage, results in an unutilized capacity of the stored energy, wherein the energy could have otherwise been utilized in the real-time market, thereby rendering the ESS less efficient. Further, maintaining the energy storage at a higher utilization than is required may result in a reduce life-expectancy of the ESS as the stored energy may promote the deterioration and/or instability in the storage devices.

### SUMMARY

The disclosure has been made in view of the above problems, and an object of the disclosure is to provide a system for storing energy in an ancillary service energy storage, and a method of operating the system.

The disclosure is not limited to the above-described tasks, and other tasks not described herein will be clearly understood by those skilled in the art from the following description.

According to an aspect of the disclosure, there is provided a system configured to store energy, the system including an ancillary service (AS) energy storage; processing circuitry configured to control a utilization of the AS energy storage; and memory including computer executable instructions configured to, when executed by the processing circuitry, cause the system to obtain system projection data, input data into a machine learning (ML) model configured to generate an output based on the system projection data, a capacity of the AS energy storage, and a generation state of one or more energy generators, the input data including the system projection data, and the output corresponding to a predicted AS utilization, and adjust a utilization threshold of the AS energy storage based on the predicted AS utilization such that a portion of the capacity of the AS energy storage is reserved as AS energy, and at least a portion of a remainder of the capacity of the AS energy storage is available for a real-time energy service.

According to an aspect of the disclosure, there is provided a method of controlling an energy storage system, the method including obtaining system projection data; inputting data into a machine learning (ML) model configured to generate an output based on the system projection data, capacity of an ancillary service (AS) energy storage, and a generation state of one or more energy generators, the input data including the system projection data, and the output corresponding to a predicted AS utilization; and adjusting a utilization threshold of the energy storage system based on the predicted AS utilization such that a portion of the capacity of the AS energy storage is reserved as AS energy, and at least a portion of a remainder of the capacity of the AS energy storage is available for a real-time energy service.

According to an aspect of the disclosure, there is provided a of training a machine learning (ML) model to forecast energy storage utilization for a system, the method including obtaining training data, the training data including historical energy system projection data and historical capacity data for energy reserves of the system; preprocessing the training data; and training the ML model using the preprocessed training data such that the ML model is configured to generate an output predicting an ancillary service (AS) utilization from energy system projection data

### BRIEF DESCRIPTION OF THE DRAWINGS

FIG. 1 is a graph illustrating the changes in energy and ancillary services prices promoting differential participation.

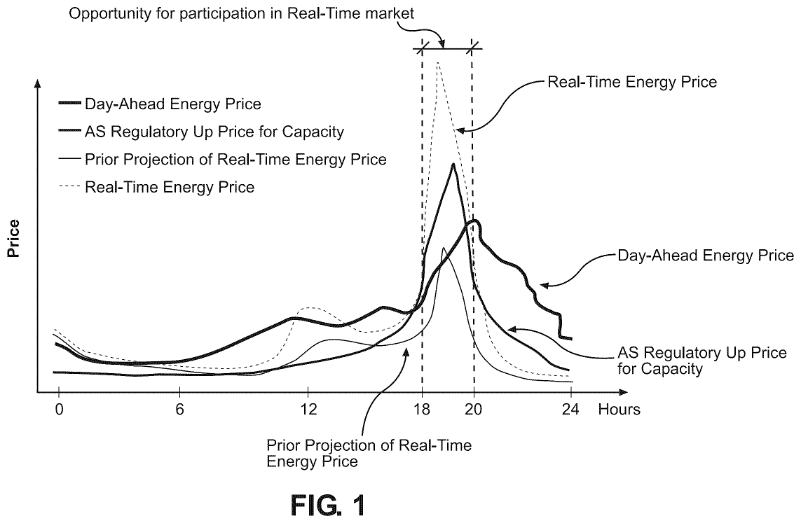

FIG. 2 is a graph illustrating the unutilized capacity in a comparative system (prior art).

FIG. 3 is a block diagram illustrating an example configuration of an energy grid including an ancillary service (AS) energy storage system.

FIG. 4 is a block diagram illustrating an example configuration of a controller configured to control the AS storage according to at least one example embodiment.

FIG. 5 is flowchart illustrating a method operation for the AS system according to at least one example embodiment.

FIG. 6 is a graph illustrating the unutilized capacity in a system according to at least one example embodiment.

### DETAILED DESCRIPTION

Hereinafter, example embodiments of the present inventive concepts will be described in detail with reference to the accompanying drawings so that those skilled in the art can easily carry out the present inventive concepts. The present inventive concepts may be embodied in various different forms and is not limited to the example embodiments described herein. In order to clearly describe the present inventive concepts, parts not related to the description are omitted in the drawings, and the same reference numerals are used to refer to the same or similar elements throughout the specification.

It should be understood that terms such as “include” or “have” are intended to describe the presence of stated features, numbers, steps, operations, elements, components, or combinations thereof, and do not preclude the presence or addition of one or more other features, numbers, steps, operations, elements, components, or combinations thereof.

Hereinafter, some example embodiments will be described with reference to the drawings.

In addition, functional elements configured to perform certain roles and/or to perform functions, may be implemented and/or supported by processing circuitry such as, hardware, software, or a combination of hardware and software unless. For example, the processing circuitry may include, but is not limited to, a central processing unit (CPU), an application processor (AP), an arithmetic logic unit (ALU), a graphic processing unit (GPU), a digital signal processor, a microcomputer, a field programmable gate array (FPGA), a System-on-Chip (SoC) a programmable logic unit, a microprocessor, or an application-specific integrated circuit (ASIC), etc., unless expressly indicated otherwise.

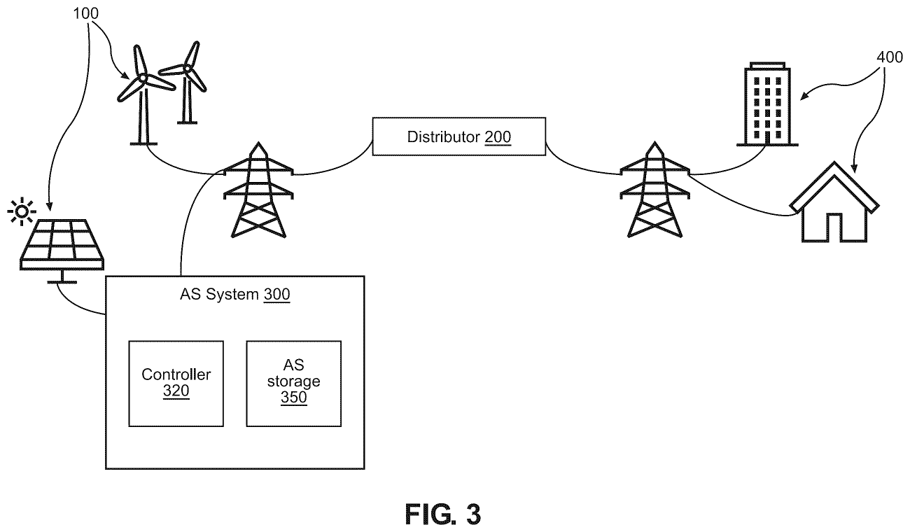

FIG. 3 is a block diagram illustrating an example configuration of an energy grid including an ancillary service (AS) energy storage system.

The energy grid includes one or more generators 100, a distributor 200, an AS system 300, and a plurality of loads 400.

The one or more generators 100 may include, for example, one or more renewable energy sources, such as a solar generator, a wind turbine, a hydroelectric dam, a geothermal generator, a wave energy generator, etc. The one more generators 100 may transmit the generated energy to a distributor 200.

The distributor 200 may be configured to collect, regulate, and distribute the energy generated to by the one or more generators 100 to the plurality of loads 400.

The plurality of loads 400 may include, for example, one or more of an industrial site, commercial site, residential site, and/or the like. The plurality of loads 400 may utilize the electricity by converting the electricity to other forms of energy, such as mechanical, thermal, light, etc.

In at least one example embodiment, the distributor 200 may include one or more substations configured to transform the voltage of the generated energy. In at least some example embodiments, the distributor 200 may be operated by an ISO.

The AS system 300 may be connected between one or more of the generators 100 and the distributor 200 (e.g., in series). However, the examples are not limited thereto. For example, in at least some example embodiments, the AS system 300 may be connected to the distributor 200 in parallel with the one or more of the generators 100.

The AS system 300 may include an AS storage 350 configured to store energy (e.g., electricity) generated by the one or more generators 100 and to operate based on the requirements set by the ISO, thereby assisting in the stability and reliability of electrical grid. For example, the operations of the AS storage 350 may include utilizing the energy stored in the AS system 300 during a peak in demand in order to stabilize the electrical grid, to provide back-up power in case of unexpected demand shifts, to stabilize voltage level in the electrical system, to provide a black start energy source, and/or any combination thereof.

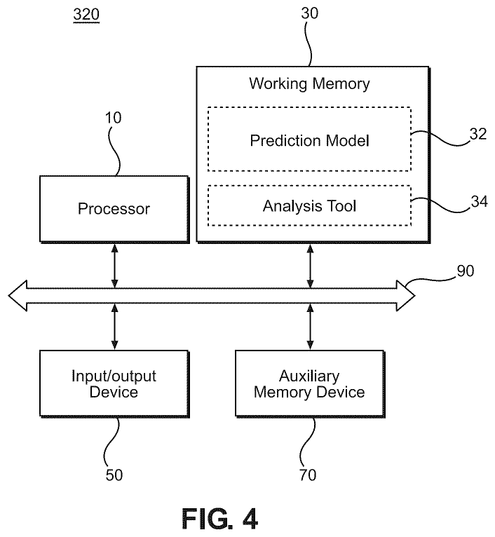

FIG. 4 is a block diagram illustrating an example configuration of a controller 320 configured to control the AS storage according to at least one example embodiment.

The controller 320 may include a processor 10 and a working memory 30. The controller 320 may further include (and/or be configured to be connected to) an input/output device 50 and an auxiliary memory device 70. The controller 320 may be provided as a dedicated device configured to train a model for predicting a utilization of the AS system 300, to predict the utilization using the trained model, and/or to update the model based on an analysis of the prediction result. The controller 320 of FIG. 4 may be equipped with various design and verification simulation programs. The controller 320 may be configured to control the operations of the AS system 300. For example, the controller 320 may be configured to control one or more of the utilization of the AS storage 350, the participation of the AS system 300 in one or more real-time energy markets, the diverting of energy to the distributor 200, etc.

The processor 10 may be configured to execute software (application program, operating system, device drivers) to be executed in the AS system 300. Therefore, the processor 10 may execute an operating system (OS, not shown) loaded into the working memory 30; and/or the processor 10 may execute various application programs based on the operating system (OS). The processor 10 is configured to execute computer executable instructions stored in the working memory 30. For example, the processor 10 may be configured to execute a utilization prediction model 32 and/or an analysis tool 34 in the working memory 30. The processor 10 may be and/or include, for example, at least one of a CPU (Central Processing Unit), an MPU (Micro Processor Unit), an MCU (Micro Controller Unit), a GPU (Graphics Processing Unit), a NPU (Neural Processing Unit) and/or other types of processors.

The operating system (OS) or the application programs may be loaded into the working memory 30. When the controller 320 including the processor 10 is booted, an OS image (not shown) stored in the auxiliary memory device 70 may be loaded into the working memory 30 based on a boot sequence. The operating system (OS) may support all input/output operations of the controller 320. The application programs may be loaded into the working memory 30 under selection by a user and/or for providing a basic service. In at least some example embodiments, the utilization prediction model 32 and/or the analysis tool 34 may be loaded into the working memory 30 from the auxiliary memory device 70 and/or through a network connection (not illustrated). Furthermore, in addition to the utilization prediction model 32 and the analysis tool 34, training data may be loaded into the working memory 30 from the auxiliary memory device 70.

The utilization prediction model 32 is configured to generate an output based on an input. The input may include, for example, one or more of system projection data, capacity data for the AS energy storage, a generation state of one or more energy generators and/or the like; and the output may represent the predicted AS utilization. For example, the output of the utilization prediction model 32 may be the predicted AS utilization and/or include data, which once converted, may generate the predicted AS utilization. For example, in at least some example embodiments, the input may include at least one of renewable energy generation forecasts, renewable energy generation states, system-level outage projections, system-level demand projections, or any combination thereof.

The utilization prediction model 32 according to at least one example embodiment may be embodied as a machine learning (ML) model, and may include one or more of a DNN (deep neural network), a gradient-boosted decision tree, a random forest, and/or any combination thereof. However, the present disclosure is not limited thereto, and the utilization prediction model 32 may be embodied using various forms of machine learning and/or artificial intelligence models.

In at least some example embodiments, in order to predict the utilization of the AS system 300, the input data may be preprocessed. For example, the preprocessing of the data may be performed by a computer program for processing of data loaded into the working memory 30. For example, in at least one example embodiment, the preprocessing the input data includes at least one of feature engineering or variable transforming the input data such that the input data is compatible with the utilization prediction model 32.

In at least one example embodiment, the controller 320 further includes an analysis tool 34 configured to analyze the output of the utilization prediction model 32 and to compare the output to a training sample (e.g., in a case wherein the utilization prediction model 32 is being trained) and/or to an actual utilization in order to monitor for deviations in accuracy of the utilization prediction model 32.

In at least some example embodiments, when the accuracy of the utilization prediction model 32 is less than a tolerance threshold, the accuracy of controller 320 may be configured to retrain the utilization prediction model 32.

The working memory 30 may be a volatile memory such as a dynamic random access memory (DRAM), a static random access memory (SRAM), or a nonvolatile memory such as a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), etc.

The input/output device 50 is configured to control user input and output from user interface devices. For example, the input/output device 50 may include a keyboard or a monitor to receive information from a designer.

The auxiliary memory device 70 is configured to function as a storage medium of the controller 320. The auxiliary memory device 70 may store therein application programs, the operating system image, and various data. The auxiliary memory device 70 may be embodied as a memory card (MMC, eMMC, SD, MicroSD, etc.) or a hard disk drive (HDD). In at least some example embodiments, the auxiliary memory device 70 may include a NAND flash memory having a large storage capacity. Alternatively, the auxiliary memory device 70 may include a next-generation nonvolatile memory such as PRAM, MRAM, ReRAM, FRAM, or a NOR flash memory.

A system interconnector 90 may be embodied as a system bus for providing a network within the controller 320. The processor 10, the working memory 30, the input/output device 50, the auxiliary memory device 70, and/or other components may be electrically connected to each other and exchange data with each other through the system interconnector 90. However, the configuration of the system interconnector 90 is not limited to the description as described above, and may further include mediation means for efficient management.

In at least some example embodiments, the controller 320 may include, for example, a network communication device (not illustrated) configured to communicate with a network and/or devices connected to the network. For example, in at least some example embodiments, the network communication device may facilitate a wire and/or wireless communication between the controller 320 and, e.g., a cloud-based server.

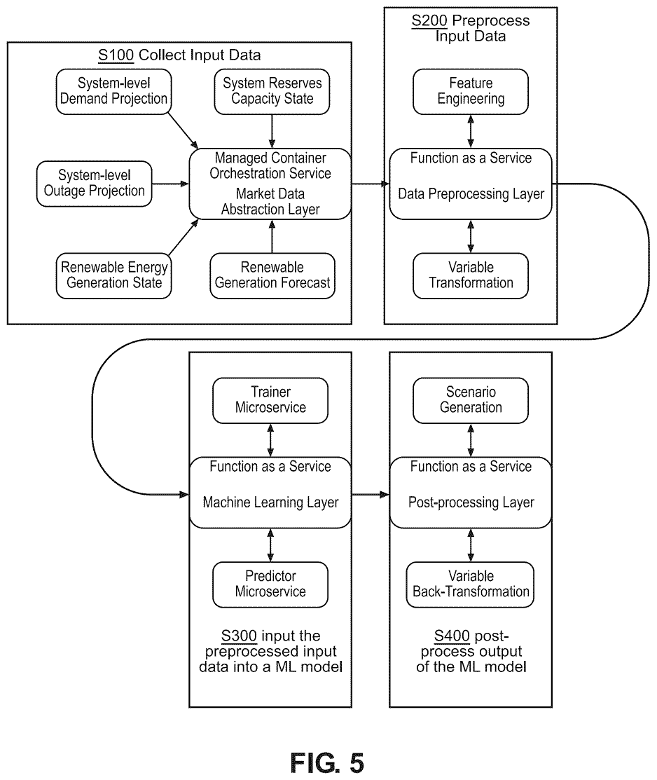

FIG. 5 is flowchart illustrating a method operation for the AS system according to at least one example embodiment.

According to at least one example embodiment, input data is collected (S100). The input data may include, for example, system projection data, a generation state of one or more energy generators, a system's reserves capacity state (e.g., deployed and undeployed ancillary services), and/or the like. In at least one example embodiment, the system projection data may include, for example, a system-level demand projection, a system-level outage projection, a renewable energy generation forecast, and/or the like. In at least one example embodiment, the system's reserves capacity state may include (or be) a representation of a capacity of the AS energy storage, and/or the generation state of one or more energy generators may include (or be) a representation of a renewable energy generation state. In at least one example embodiment, the input data may be collected using a management container orchestration service system configured to manage internal systems and/or systems connected to and controller by the operating systems of the AS system 300, and/or using a market data abstraction layer configured to collect and/or generate the system projection data.

The collected input data may be configured as training data. The training data may be historical data selected as an input for training (or retraining) a ML model (e.g., the utilization prediction model 32). For example, the training data may include historical system-level demand projections, historical system-level outage projections, historical renewable energy generation forecasts, and/or the like. In at least some example embodiments, the training data may further include data representing an actual historical utilization as a comparison for an output of the ML model.

In at least one example embodiment, the input data is preprocessed (S200). In at least some example embodiments, the pre-processing may be performed based on a function as a service (FAAS) and/or at a data preprocessing layer. For example, the collecting (S100) and/or the pre-processing (S200) of the data may be done locally (e.g., in the AS system 300) and/or in a platform-level cloud system external to and accessible by the AS system 300. In at least some example embodiments, the pre-processing may include at least one of a feature engineering process and/or a variable transformation process configured to select, extract, and/or transform the collected input data into a ML model compatible format. The feature engineering may include, for example, featurization of the system reserves capacity states (e.g., the deployment levels), aggregation of the observed and projected renewable energy sources, and the aggregation of the system-wide load and outage projections; the variable transformation may involve, for example, transforming the ancillary services utilization (e.g. the deployment) data from Beta distributions to univariate and/or multi-variate Gaussian space. In at least one example embodiment, the feature engineering and variable transformation may be, collectively, a single microservice.

In at least one example embodiment, the pre-processed input data is input into a ML model (S300). The ML model may be, for example, the utilization prediction model 32 described above, and/or a FAAS based ML model configured to predict a utilization of the AS storage 350.

The ML model may include a trainer service and a predictor service. In at least one example embodiment, the trainer and/or predictor service may be a microservce (e.g., a serverless deployment). The trainer service may be configured to learn the relationship between historical feature values and ancillary services utilization (deployment) levels and to produce an output based on the learned relationship wherein the output represents a predicted AS utilization; and the predictor service may be configured to provide confidence intervals for the output of the trainer service. The confidence intervals may represent, for example, a confidence that the predicted utilization matches the historical utilization. The confidence intervals may be, for example, may be represented by a percentile wherein a lower percentile (e.g., between 0% to 50%) may indicate an inaccurate value outside a standard deviation curve, a medium percentile (e.g., between 50% to 90%) may indicate that the exceed prediction represented in the output is within the standard deviation curve but outside a permissible standard deviation range; and higher percentile (e.g., between 90% to 95%, 95% to 99.9%, 99.9% to 99.99%, etc.) may indicate that the prediction represented by the output is within permissible standard deviation ranges. In at least some example embodiments, the confidence intervals may be represented by, e.g., a bell-curve, Gaussian distribution, and/or the like, divided into quantiles. However, these are just some examples, and the examples are not limited thereto. In at least some example embodiments, the trainer service may be configured ensure that the predicted value is always greater than the historical value.

In at least some example embodiments, the trainer service may be configured to provide a prediction for a set time period (e.g., a 24-hour period), wherein the output includes a predicted utilization for each of a time increment (e.g., one or more of a 1 minute increment, a 10 minute increment, a 30 minute increment, a 1 hour increment. etc.) of the time period. For example, in a case wherein the time period is set to be a 24-hour period with 10 minute increments, the output may prediction of the utilization of the AS storage 350 include one hundred forty-four (144) data points. Additionally, the predictor service may be configured to provide a confidence interval for some of or all of the data points. However, these are just some examples, and the example embodiments are not limited thereto.

In at least one example embodiment, the training service may include a supervised training, an unsupervised training, a reinforcement training, and/or the like. For example, in least one example embodiment, an output of the ML model is compared to a historical utilization corresponding to the input data, and internal parameters (e.g., the weights) of the ML model are adjusted based on an outcome of the comparison. In at least one example embodiment, the comparison and adjustment may be repeated until the output representing the predicted utilizations are substantially similar to the corresponding historical utilizations and the confidence internal is above a tolerance threshold.

In at least one example embodiment, the tolerance threshold may be adjustable. For example, in at least one example embodiment the tolerance threshold may be set to a low risk (e.g., a 99.99% confidence); a mid-risk (e.g., a 95% confidence); a high risk (e.g., a 90% confidence); and the training of the ML model adjust accordingly. However, these are just some examples, and the example embodiments are not limited thereto. Alternatively, in at least some example embodiments, the ML model may be trained to have an adjustable confidence. In at least one of these cases, the predictor service may be configured to enable and/or restrict connections in the ML model based on the selected confidence.

In at least one example embodiment, the output of the ML model undergoes one or more post-processing operations (S400). In at least one example embodiment, the post-processing may be (or include) a FAAS operation.

The post-processing operations may include, for example, a scenario generation component that is configured to convert the quantiles of the output into autocorrelative probabilistic scenarios on-demand for use in stochastic co-optimization of multi-market participation, and/or a back-transformation component configured to back-transform univariate or multi-variate Gaussian quantiles of the output and realizations thereof to Beta distributions. In at least one example embodiment, the scenario generation and variable back-transformation components may be collectively a single microservice.

For example, in at least one example embodiment, the autocorrelative probabilistic scenarios may be generated to ensure that a forecasted utilization generated from the output of the ML model includes a buffer such that a portion of the capacity of the AS storage 350 remains unutilized. In at least some example embodiments, the scenario generation component may base the autocorrelative probabilistic scenarios on the output of the trainer service and the predictor service. For example, the scenario generation component may be configured to provide different autocorrelative probabilistic scenarios based on the different confidence levels. In these cases, the autocorrelative probabilistic scenarios corresponding to the different confidence levels may each represent a confidence that the autocorrelative probabilistic scenarios will not be exceeded by the actual utilization. For example, in the case wherein the confidence interval included 90% to 95%, 95% to 99.9%, 99.9% to 99.99% quantiles, the scenario generation component may be configured to produce at least one of a comparatively low risk autocorrelative probabilistic scenario based on the 99.9% and higher quantile, a medium risk autocorrelative probabilistic scenario based on the 95% to 99.9% quantile, and/or a higher risk autocorrelative probabilistic scenario based on the 90% to 95% quantile. In at least some embodiments, the quantile from which the autocorrelative probabilistic scenario is based may be selected based on the selection of a user, based on by a service tier applied through a subscription service, and/or the like.

In at least one example embodiment, the output the post-processing operations may be included as part of the training ML, e.g., as an additional analysis step; and/or may be provided after the training of the ML model, e.g., as a confirmation step. In at least some example embodiments, the post-processing may be omitted during the training of the ML model.

In at least one example embodiment, the ML model is configured to switch between a training (or retraining) mode or in a prediction mode. For example, the pre-processed input data may include an identifier, identifying the input data as training data or processing data and the ML model may switch modes based on the identifier; however, the example embodiments are not limited thereto. For example, in least one example embodiment, the ML model may be configured to switch between the two modes based on a command from a user and/or from a determination that accuracy of the output of the ML model as drifted outside of a tolerance threshold.

In at least one example embodiment, after the training of the ML model the ML model may be configured to switch to and operate under the prediction mode.

While in the prediction mode, the internal parameters of the ML model may be locked (e.g., prevented from being modified). For example, modifications to the weights of the ML model may be prevented.

Additionally, while in the prediction mode, the ML model may receive pre-processed data from the data pre-processing layer. The pre-processed data received while in the prediction mode may include data corresponding to day-ahead and/or real time data received from the managed container orchestration service and/or the market data abstraction layers. The ML model may output an output based on the day-ahead and/or real time data and the learned relationship, wherein the output represents a predicted AS utilization.

Additionally, in at least some example embodiments, the output may undergo one or more post-processing processes, wherein, e.g., the output of the ML model is converted into autocorrelative probabilistic scenarios and/or univariate or multi-variate Gaussian quantiles of the output and realizations thereof are back-transformed.

The AS system 300 may be configured to adjust a participation in one or more real-time energy markets by adjusting the utilization threshold of the AS storage 350 based on the predicted utilization and/or a selected probabilistic scenario. The adjusting of the utilization threshold results in a portion of the capacity of the AS energy storage 350 being resolved as AS energy (e.g., for participation in the ancillary services), and makes available at least a portion the remainder for the capacity of the AS energy storage available to a real-time energy service (e.g., for participation the real-time energy market).

In at least one example embodiment, a utilization threshold may be adjusted during the selected time period based on the predicted utilization represented in the output of the ML model and/or the autocorrelative probabilistic scenarios. For example, the utilization threshold may be based on a confidence interval, wherein, e.g., a first confidence interval, based on the 90% to 95% quantile, represents a prediction with a lower unutilized capacity compared to a second confidence interval based on the higher 99% or higher quantile, but wherein the utilization threshold based on the first confidence interval has an increased chance of the actual utilization exceeding the utilization threshold. In other words, the utilization threshold based on the higher second confidence interval (e.g., 99%) may increase the unutilized capacity, thereby reducing the efficiency of the AS storage 350 compared to the utilization threshold based the lower first confidence interval (e.g., 90%), but may also reduce the potential for penalties for inadequacy violations (e.g., not being able to satisfy the actual AC utilization demands). As the magnitude of the utilization threshold based on the first confidence interval is also generally lower than the magnitude of the utilization threshold based on the second confidence interval, an average of the utilization tolerance based on the second confidence interval may be greater than an average of the utilization tolerance based on the second confidence interval. In at least one example embodiment, the adjustable confidence interval may be enabled by, e.g., the predictor service and/or by a post-processing processes. For example, in least one example embodiment, the adjustable confidence interval may be adjusted based on an adjustment of a range increment of the quantiles of the predictor service; and/or the selection of a higher-risk quantile during the post-processing operation.

In at least some example embodiments, the adjustment of the AS energy storage 350 may include storing energy in the AS energy storage when the utilization of the AS energy storage is below the utilization threshold, and matching the utilization threshold (e.g., by releasing energy from the AS system 300 and/or by diverting energy generated by the one or more energy generators 100 towards a real-time energy market) such that the utilization of the AS energy storage 350 matches the utilization threshold. The releasing of energy into the real-time energy market may include releasing energy into one or more real-time energy operating systems. Additionally, the releasing of energy into the real-time energy market may include maintaining a magnitude of a utilization tolerance such that the AS storage 350 maintains an unutilized capacity. The releasing of energy into the real-time energy operating system may include maintaining a magnitude of a utilization tolerance such that the AS storage 350 maintains an unutilized capacity. More specifically, the unutilized capacity may serve as a buffer in case of a higher than predicted utilization of the energy in the AS storage 350.

Additionally, the adjustment of the AS energy storage 350 may include increasing a utilization threshold of the AS energy storage 350 prior to an increase in the predicted AS utilization and decreasing the utilization threshold of the AS energy storage 350 after a decrease in the predicted AS utilization. In other words, the utilization threshold of the AS energy storage 350 may be increased to match a predicted increase in regulation utilization demand and decrease to match a predicted decrease in the regulation utilization demand; while the efficiency of the AS system 300 increases due to the participated is the real-time energy market during, e.g., increases of the price in the real-time energy market.

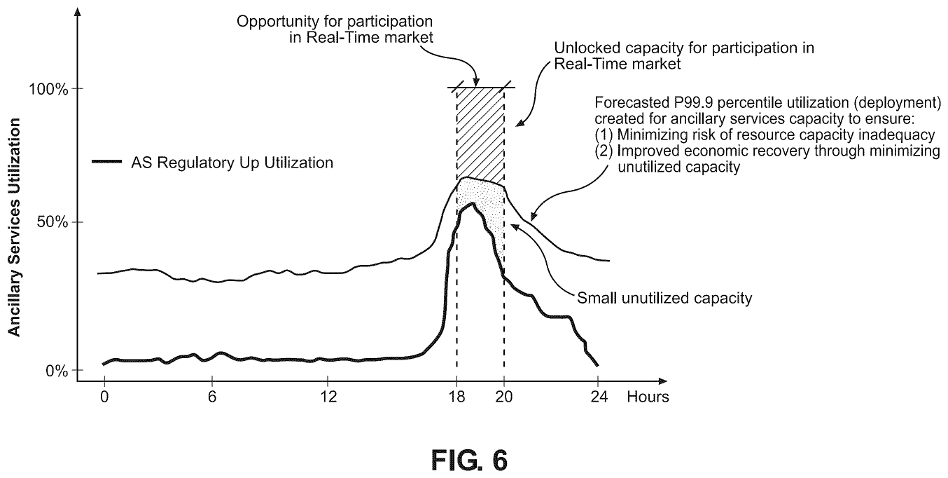

FIG. 6 is a graph illustrating the unutilized capacity in a system according to at least one example embodiment.

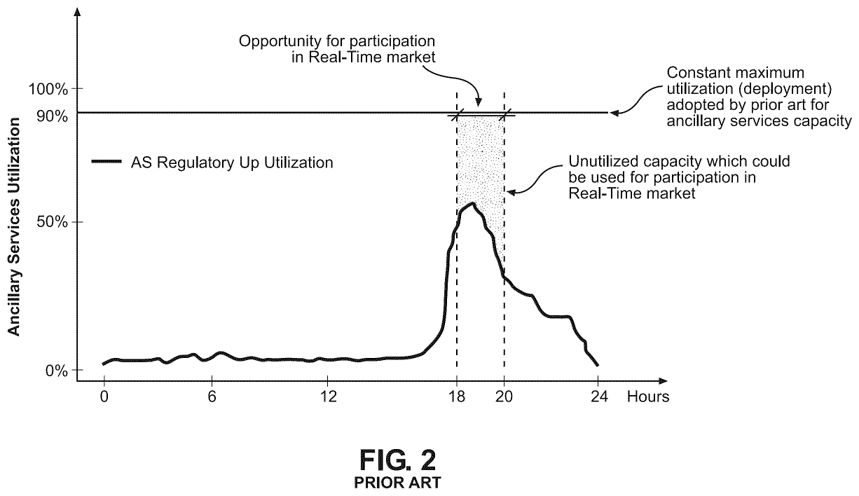

As shown in FIG. 6, since the utilization threshold of the AS storage 350 matches the actual utilization more closely than the comparative example (see, FIG. 2), the unutilized capacity of the AS storage 350 is also reduced, and the efficiency of the AS system 300 may be increased. More specifically, in the example illustrated in FIG. 6, the utilization threshold is matched to the predicted utilization of the AS storage 350, while, in the comparative example (see, FIG. 2), the utilization threshold is set at a constant of 90%; as a result, an unutilized capacity of the comparative example is greater than the unutilized capacity of the example embodiment, and therefore the comparative example is less efficient compared to the illustrated example.

Thereby, the present inventive concepts dynamically unlocks the reserves stored in the AS system 300 (which have a low probability of being fully utilized) for participation in the real-time electricity market while ensuring that the risk of resource inadequacy violations remains small. The present inventive concepts further provides support for a stochastic co-optimization of ESS assets, which can further improve the economics and operations of the ESS assets.

Although some example embodiments of the present inventive concepts are described, the spirit of the present inventive concepts is not limited to the example embodiments presented in the specification, and those skilled in the art who understand the spirit of the present inventive concepts may easily propose other embodiments within the same scope of the spirit of the present inventive concepts by adding, modifying, deleting, and adding components, but this is also within the scope of the present inventive concepts.

What is claimed is:

1. A system configured to store energy, the system comprising:
an ancillary service (AS) energy storage;
processing circuitry configured to control a utilization of the AS energy storage; and
memory including computer executable instructions configured to, when executed by the processing circuitry, cause the system to
obtain system projection data,
input data into a machine learning (ML) model configured to generate an output based on the system projection data, a capacity of the AS energy storage, and a generation state of one or more energy generators, the input data including the system projection data, and the output corresponding to a predicted AS utilization, and
adjust a utilization threshold of the AS energy storage based on the predicted AS utilization such that a portion of the capacity of the AS energy storage is reserved as AS energy, and at least a portion of a remainder of the capacity of the AS energy storage is available for a real-time energy service.

2. The system of claim 1, wherein
the system is further configured to store energy in the AS energy storage when a utilization of the AS energy storage is below the utilization threshold, and to match the utilization threshold by releasing energy from the system towards a real-time energy operating system such that the utilization of the AS energy storage matches the utilization threshold, and
the utilization threshold is based on the predicted AS utilization.

3. The system of claim 2, wherein
the system is configured to have adjustable confidence intervals, and
an average of the utilization threshold for a first confidence interval is greater than an average of the utilization threshold for a second confidence interval, and
an unutilized capacity of the first confidence interval is greater than an unutilized capacity of the second confidence interval.

4. The system of claim 2, wherein the utilization threshold includes at least a first period and a second period during a set time period, and
a magnitude of the utilization threshold during the first period is less than a magnitude of the utilization threshold during the second period.

5. The system of claim 2, wherein the matching the utilization threshold further includes diverting energy generated by the one or more energy generators to the real-time energy service.

6. The system of claim 1, wherein the data input into the ML model includes data representing at least one of renewable energy generation forecasts, renewable energy generation states, system-level outage projections, system-level demand projections, or any combination thereof.

7. The system of claim 1, wherein the ML model was trained by
obtaining training data; and
training the ML model using the training data such that the ML model is configured to generate the output, and
wherein the training data includes at least one of historical renewable energy generation forecasts, historical renewable energy generation states, historical system-level outage projections, historical system-level demand projections, historical system reserves capacity states, or any combination thereof.

8. The system of claim 1, wherein the system is further comprised to
preprocess the system projection data, and
the preprocessing the system projection data includes at least one of feature engineering or variable transforming the system projection data such that the system projection data is compatible with the ML model.

9. The system of claim 1, wherein the system is configured to participate in a real-time energy market using the portion of the capacity of the AS energy storage available for the real-time energy service.

10. A method of controlling an energy storage system, the method comprising:
obtaining system projection data;
inputting data into a machine learning (ML) model configured to generate an output based on the system projection data, capacity of an ancillary service (AS) energy storage, and a generation state of one or more energy generators, the input data including the system projection data, and the output corresponding to a predicted AS utilization; and
adjusting a utilization threshold of the energy storage system based on the predicted AS utilization such that a portion of the capacity of the AS energy storage is reserved as AS energy, and at least a portion of a remainder of the capacity of the AS energy storage is available for a real-time energy service.

11. The method of claim 10, further comprising:
comparing the predicted AS utilization to a training AS regulation utilization; and
updating the ML model based on a result of the comparing being outside of tolerance.

12. The method of claim 10, further comprising:
releasing energy into the real-time energy service such that a utilization of the AS energy storage system matches a utilization threshold.

13. The method of claim 10, wherein the utilization threshold is set such that a magnitude of the utilization threshold includes an unutilized capacity.

14. The method of claim 13, further comprising:
post-processing the output such that an autocorrelative probabilistic scenario is generated,
wherein the utilization threshold is based on the autocorrelative probabilistic scenario,
the autocorrelative probabilistic scenario is based on a confidence interval from a plurality of confidence intervals,
an average of the utilization threshold for a first of the plurality of confidence intervals is greater than an average of the utilization threshold for a second of the plurality of confidence intervals, and
the unutilized capacity of the utilization tolerance for the first confidence interval is greater than the unutilized capacity of the utilization tolerance for the second confidence interval.

15. The method of claim 10, wherein the adjusting the utilization includes increasing the utilization threshold of the AS energy storage prior to an increase in the predicted AS utilization.

16. The method of claim 10, wherein the adjusting the utilization includes decreasing the utilization threshold of the AS energy storage after a decrease in the predicted AS utilization.

17. The method of claim 10, wherein the data input into the ML model includes data representing at least one of renewable energy generation forecasts, renewable energy generation states, system-level outage projections, or system-level demand projections.

18. The method of claim 10, further comprising:
participating in a real-time energy market using the portion of the capacity of the AS energy storage available for the real-time energy service.

19. A method of training a machine learning (ML) model to forecast energy storage utilization for a system, the method comprising:
obtaining training data, the training data including historical energy system projection data and historical capacity data for energy reserves of the system;
preprocessing the training data; and
training the ML model using the preprocessed training data such that the ML model is configured to generate an output predicting an ancillary service (AS) utilization from energy system projection data.

20. The method of claim 19, wherein the training the ML model includes:
training the ML model such that a confidence interval of the predicted AS utilization is adjustable.
